(19) United States
(12) Patent Application Publication
(10) Pub. No.: US 2008/0061490 A1
(43) Pub. Date: Mar. 13, 2008

(54) Sheet post-process system and sheet post-processing method

(75) Inventors: Yasunobu Terao, Shizuoka-ken (JP); Yoshiaki Sugizaki, Shizuoka-ken (JP); Mikio Yamamoto, Shizuoka-ken (JP); Tomomi Iijima, Shizuoka-ken (JP); Hiroyuki Taki, Shizuoka-ken (JP)

Correspondence Address: FOLEY AND LARDNER LLP;SUITE 500, 3000 K STREET NW, WASHINGTON, DC, 20007, US

(73) Assignee: TOSHIBA TEC KABUSHIKI KAISHA

(21) Appl. No.: 11/976,140

(22) Filed: Oct. 22, 2007

Related U.S. Application Data
(63) Continuation of application No. 11/085,240, filed on Mar. 22, 2005.

(30) Foreign Application Priority Data
Sep. 29, 2004 (JP) 2004-285285

(51) Int. Cl. B65H 37/04; B41L 43/00; B65H 37/06

(52) U.S. Cl. 270/37; 270/58.11

(57) ABSTRACT

Above a processing tray, a standby tray for making sheets of paper P stand by is installed. The sheets of paper P on the standby tray are dropped, fed, and moved to the processing tray, thus the conveying path from the standby tray to the processing tray is shortened. Furthermore, a Z-folding mechanism is arranged above the standby tray, and the sheets of paper P folded in a Z shape are dropped, and are mixed and stapled on the standby tray or processing tray, and even when performing a plurality of post processes for sheets, miniaturization of a sheet post-process system is retained.

### CROSS-REFERENCE TO RELATED APPLICATION

The present application is a continuation of U.S. application Ser. No. 11/085,240, filed Mar. 22, 2005, the entire contents of which is incorporated herein by reference.

This application is based upon and claims the benefit of priority from prior Japanese Patent Application No. 2004-285285 filed on Sep. 29, 2004, the entire contents of which are incorporated herein by reference.

### BACKGROUND OF THE INVENTION

1. Field of the Invention

The present invention relates to a sheet post-process system and a sheet post-processing method for post-processing sheets of paper ejected from an image forming apparatus such as a copier, a printer, or a composite device.

2. Description of the Related Art

In recent years, in an image forming apparatus, to post-process sheets of paper after image forming such as sorting or stapling sheets of paper, a sheet post-process apparatus may be installed in the neighborhood of the paper ejection unit of the image forming apparatus body. To make succeeding sheets ejected from the image forming apparatus body stand by like this, conventionally, in Japanese Patent Publication 6-99070, an apparatus installing a shifting path halfway the path toward a stapler is disclosed. Further, in Japanese Patent Publication 6-83132, an image forming apparatus for matching a sheet of paper on which an image is formed on an intermediate tray and then re-sending it toward image forming is disclosed.

However, as in the conventional apparatus, when a shifting path is installed halfway the path toward the stapler, the length of the conveying path from the paper ejection section of the image forming apparatus body to the stapler becomes longer, thus a problem arises that miniaturization of the apparatus is disturbed.

Therefore, a sheet post-process system and a sheet post-processing method capable of shortening the distance from the paper ejection section of the image forming apparatus to the processing mechanism for performing the post process and realizing miniaturization are desired.

### SUMMARY OF THE INVENTION

An object of this embodiment of the present invention is to provide a sheet post-process system and a sheet post-processing method for shortening the distance from the paper ejection section of the image forming apparatus to the processing mechanism for performing the post process and realizing miniaturization of the image forming apparatus.

According to this embodiment of the present invention, the sheet post-process system comprises a first processing mechanism for performing a first post-process for sheets ejected from the image forming apparatus, a standby tray for making sheets ejected from the image forming apparatus and/or sheets ejected from the first processing mechanism stand by, a gate for branching the sheets ejected from the image forming apparatus to either of the first processing mechanism and the standby tray, a processing tray arranged under the standby tray for loading the sheets dropped and fed from the standby tray and the sheets ejected from the image forming apparatus or the first processing mechanism not via the standby tray, a second processing mechanism for performing a second post process for the plurality of sheets loaded on the processing tray, and a paper ejection tray for at least loading the sheets ejected from the processing tray after ending of the second post process.

### BRIEF DESCRIPTION OF THE DRAWINGS

FIG. 1 is a perspective view showing the essential section of the sheet post-process apparatus of the embodiment of the present invention,

FIG. 2 is a top view showing the essential section of the sheet post-process apparatus of the embodiment of the present invention,

FIG. 3 is a schematic block diagram showing the sheet post-process apparatus of the embodiment of the present invention,

FIG. 4 is a perspective view showing the stapler of the sheet post-process apparatus of the embodiment of the present invention,

FIG. 5 is a perspective view showing the vertical matching roller of the embodiment of the present invention,

FIG. 6 is an illustration showing the paddle of the embodiment of the present invention,

FIG. 7 is a schematic perspective view showing the standby tray and processing tray of the embodiment of the present invention,

FIG. 8 is a top view showing the standby tray and processing tray of the embodiment of the present invention,

FIG. 9 is a schematic perspective view showing the horizontal matching plate and conveyor belt of the embodiment of the present invention,

FIG. 10 is an illustration showing feed of sheets of paper from the Z-folding mechanism of the embodiment of the present invention, and

FIG. 11 is an illustration showing movement of the standby tray of the embodiment of the present invention.

### DETAILED DESCRIPTION OF THE INVENTION

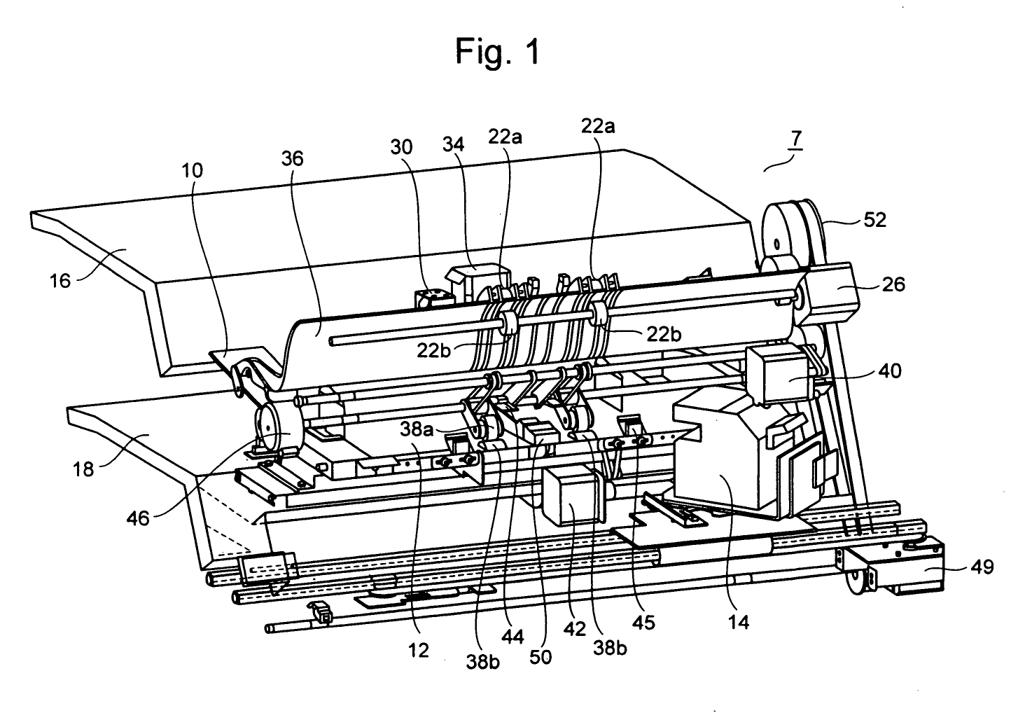

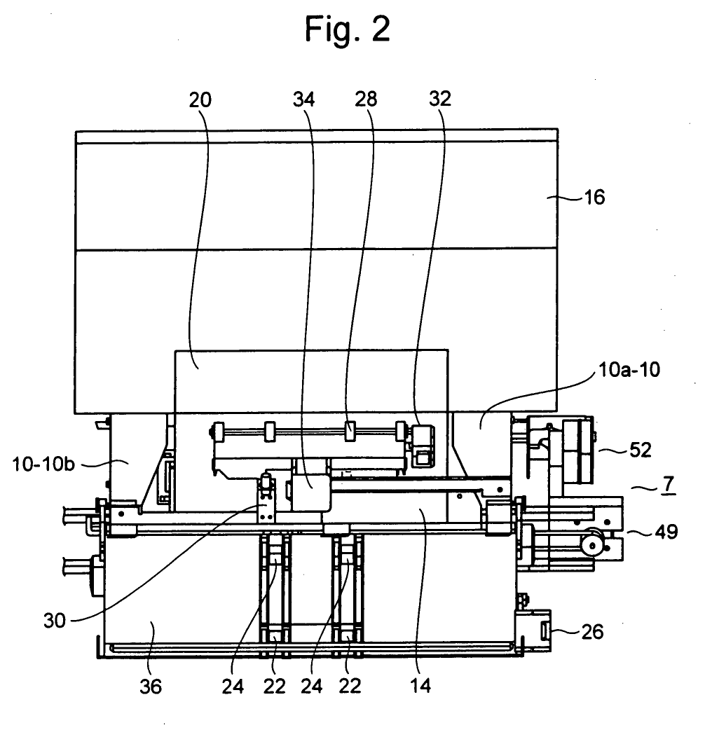

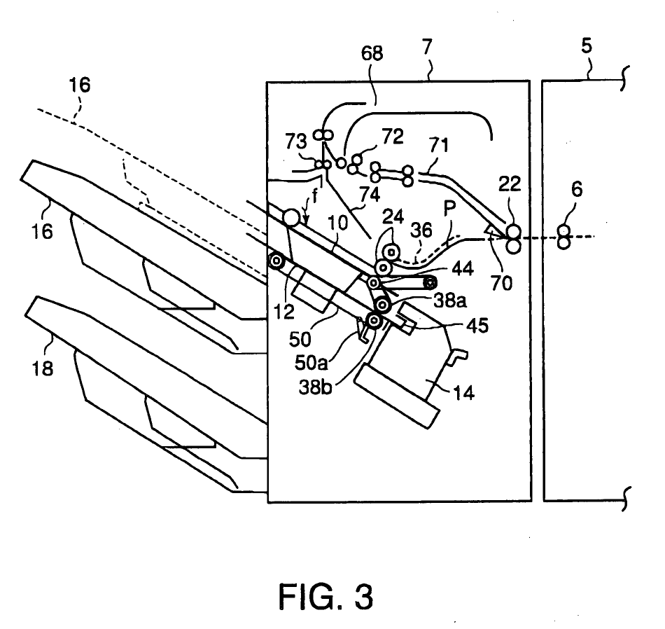

Hereinafter, the embodiment of the present invention will be explained in detail with reference to the accompanying drawings. FIG. 1 is a perspective view showing the essential section of a sheet post-process apparatus 7 of the embodiment of the present invention, and FIG. 2 is a top view showing the essential section of the sheet post-process apparatus, and FIG. 3 is a schematic block diagram showing the sheet post-process apparatus 7 arranged in the neighborhood of an image forming apparatus 5 such as a copier. The sheet post-process apparatus 7 has a pair of entrance rollers 22 for fetching a sheet of paper P on which an image is formed by the image forming apparatus 5 and which is ejected by a pair of paper ejection rollers 6 into the sheet post-process apparatus 7. The entrance rollers 22 are driven by an entrance roller motor 26.

On the downstream side of the entrance rollers 22, a gate 70 which is a first processing mechanism for performing the Z-folding process, which is the first post process, for distributing the sheets of paper P to the side of a Z-folding mechanism 68 for performing the first processing step and to the side of the standby tray 10 for performing the standby step is installed. Between the gate 70 and the Z-folding mechanism 68, a folding path 71 for leading the sheets of paper P to be Z-folded is installed. Between the gate 70 and a standby tray 10, a paper path ceiling 36 for leading the sheets of paper P to a pair of paper feed rollers 24 is installed. Under the standby tray 10, a processing tray 12 for performing the loading step for loading the sheets of paper P dropped and fed from the standby tray 10 is arranged.

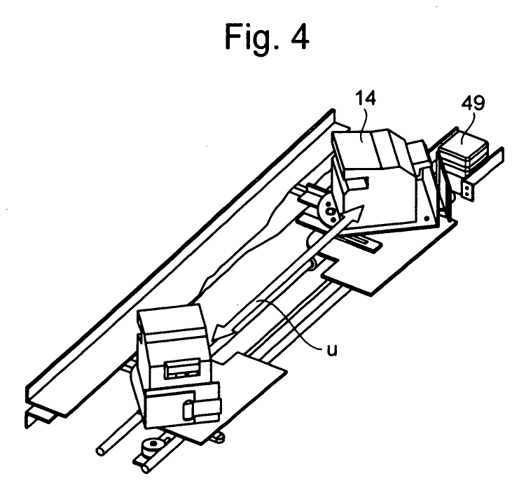

The processing tray 12, while the sheets of paper P are stapled by the stapler 14 which is a second processing mechanism for performing the stapling process for performing the second processing step which is the second post-process, matches and supports the sheets of paper P to be loaded. As shown in FIG. 4, the stapler 14 can slide and move in the direction of the arrow u by a stapler driving unit 49 and is rotated, moved, and positioned according to the stapling direction, thus the stapling process is controlled.

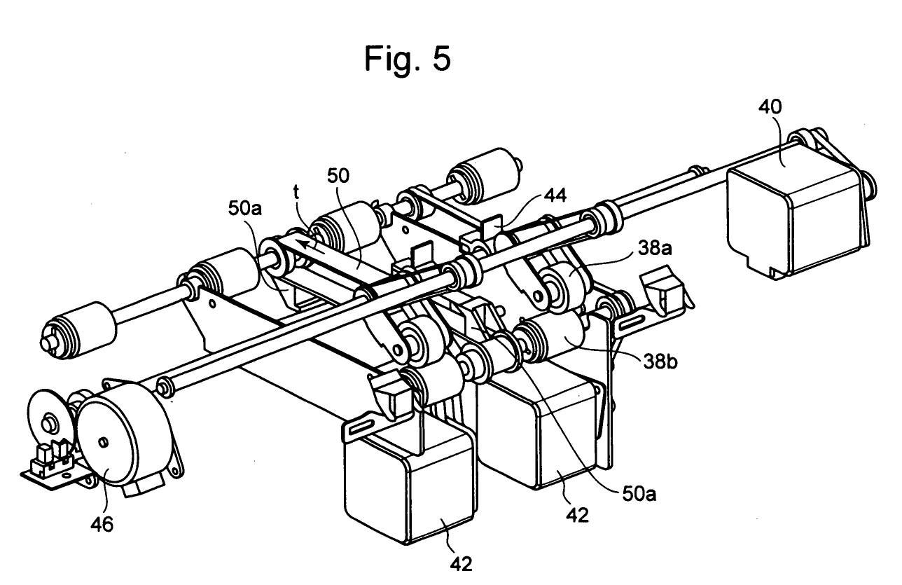

The processing tray 12 has a pair of upper vertical matching roller 38a and lower vertical roller 38b shown in FIG. 5. The upper vertical matching roller 38a and lower vertical roller 38b match a plurality of sheets of paper P dropped and fed from the standby tray 10 in the vertical direction which is a conveying direction. The upper and lower vertical matching rollers 38a and 38b serve as bundle conveying rollers for holding a sheet bundle T after stapled and taking out it from the stapler 14. The upper vertical matching roller 38a is driven by a vertical matching upper roller motor 40 and the lower vertical matching roller 38b is driven by a vertical matching lower roller motor 42.

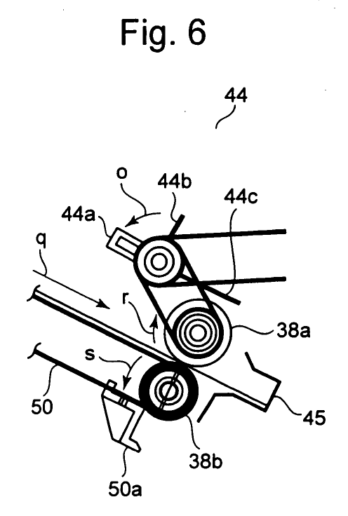

Further, when the sheets of paper P are dropped and fed on the processing tray 12, at the position where the rear end of each of the sheets of paper P is dropped, a rotatable paddle 44 for matching vertically the uppermost sheet of paper P loaded on the processing tray 12 is arranged. The paddle 44, as shown in FIG. 6, has a receiving portion 44a of the sheets of paper P dropped and fed onto the processing tray 12, a beating portion 44b for beating down the sheets of paper P on the processing tray 12, and a feeding portion 44c for matching the sheets of paper P on the processing tray 12 and it is driven by a paddle motor 46. The paddle 44 is composed of an elastic rubber material.

At the end of the processing tray 12 on the side of the stapler 14, a stopper 45 for making contact with the rear end of each of the sheets of paper P and controlling the rear end position. Almost at the center of the processing tray 12, a conveyor belt 50 which is a conveyor mechanism for making contact with the lowest sheet of paper P on the processing tray 12 is installed. The conveyor belt 50 conveys the sheet bundle T, which is stapled and taken out from the stapler 14 by the upper and lower vertical matching rollers 38a and 38b, up to the first or second paper ejection tray 16 or 18 which is a paper ejection means. To the conveyer belt 50, a feed pawl 50a for hooking the rear end of the sheet bundle T is attached.

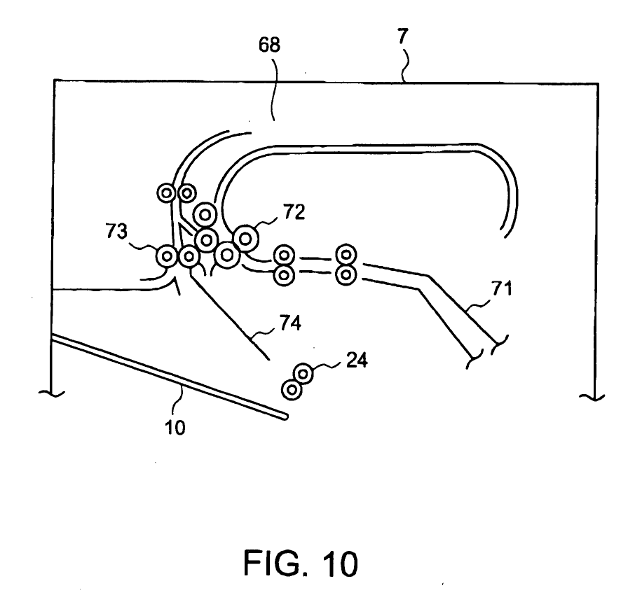

A Z-folding mechanism 68 shown in FIG. 10 folds the sheets of paper P taken in from a first pair of feed rollers 72 and can drop and feed them, guided by a drop guide 74, onto the standby tray 10. When the sheets of paper P taken in from the first pair of feed rollers 72 are folded in a Z shape and then are not stapled, they can be conveyed from the second pair of feed rollers 73 toward the first or second paper ejection tray 16 or 18.

The standby tray 10 can drop and feed the sheets of paper P onto the processing tray 12 and also can convey the sheets of paper P toward the first or second paper ejection tray 16 or 18. When conveying the sheets of paper P toward the paper ejection trays 16 and 18, a standby tray roller 28 for matching the sheets of paper P makes contact with the sheets of paper P on the standby tray 10. The standby tray roller 28 is controlled in the vertical movement by a standby tray roller driving source 30 and is driven to rotate by a standby tray roller motor 32.

The standby tray 10 is inclined so that the front end of the sheets of paper P is positioned higher than the rear end thereof. The first or second paper ejection tray 16 or 18 is moved up and down by a paper ejection tray driving unit 52 and either of them is selected. The first or second paper ejection tray 16 or 18 is moved up and down up to almost the same height as that of the standby tray 10 or the processing tray 12 when loading the sheets of paper P to improve the consistency of the sheets of paper P to be ejected. The first or second paper ejection tray 16 or 18 is inclined so that the front end of the sheets of paper P is positioned higher than the rear end thereof.

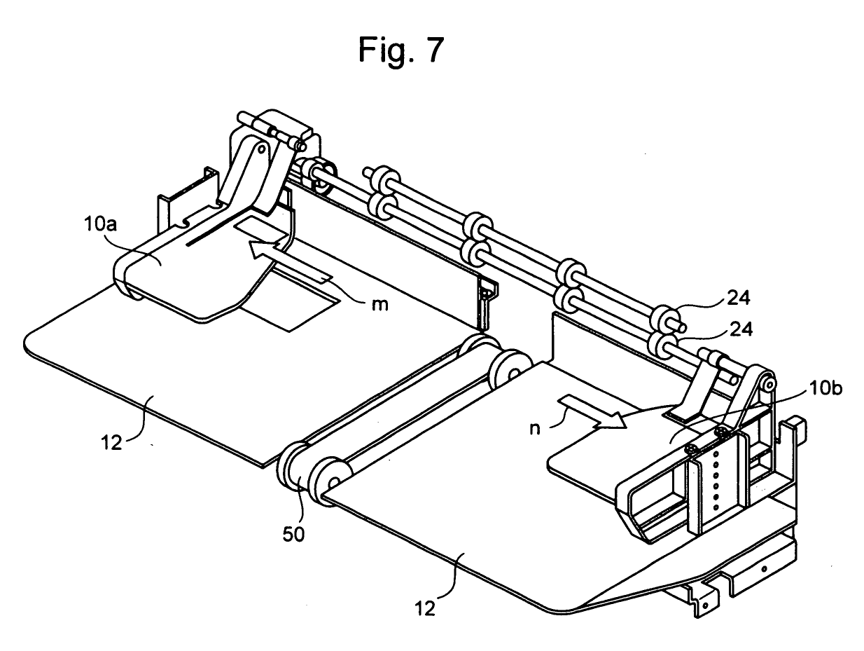

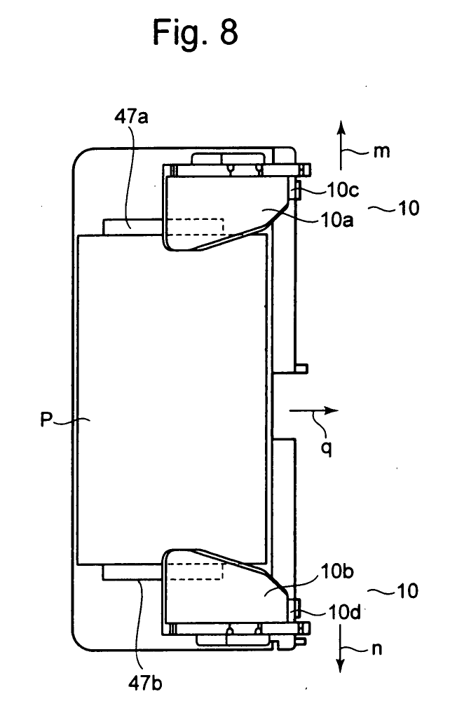

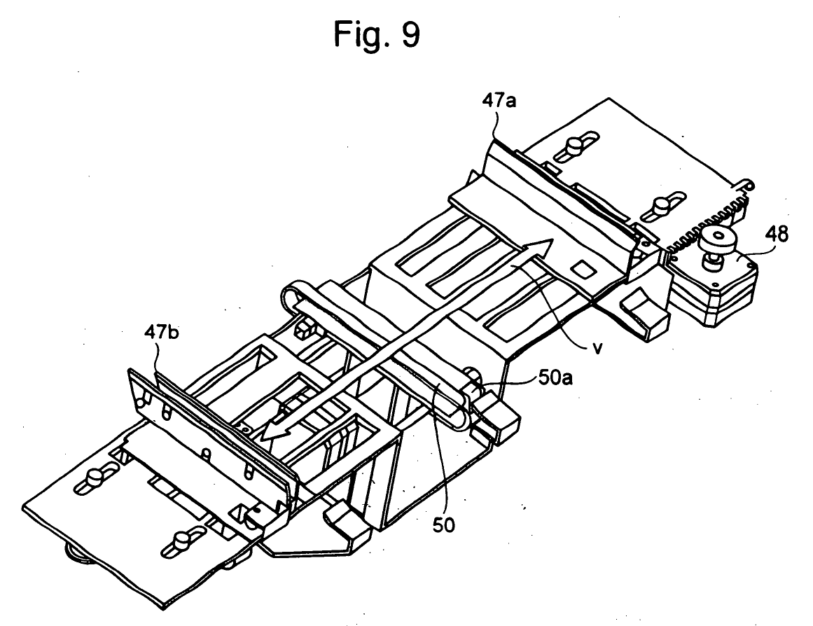

As shown in FIGS. 7 and 8, the standby tray 10 has a pair of tray members 10a and 10b, receives the sheets in a state that it slides in the width of the paper P and supports both sides of the paper P. On the tray members 10a and 10b, standby stoppers 10c and 10d for controlling the rear ends of the sheets of paper P are installed. The standby tray 10 slides and moves by the standby tray motor 34. Between the standby tray 10 and the processing tray 12 where it reaches, when dropping and feeding the sheets of paper P from the standby tray 10 onto the processing tray 12, horizontal matching plates 47a and 47b shown in FIG. 9 for preventing the sheets of paper P from turning away in the horizontal direction perpendicular to the conveying direction and matching them horizontally are installed. The horizontal matching plates 47a and 47b are formed slidably in the direction of the arrow v so as to fit to the width of the sheets of paper P by a horizontal matching motor 48.

Next, the operation of the invention will be described. When an image is formed by the image forming apparatus 5 and a sheet of paper P is fed from the paper ejection rollers 6, the sheet post-process apparatus 7, depending on a case of performing the post-process of the sheet of paper P or a case of performing no post-process, or while the preceding sheet of paper P is in execution of the post-process or the post-process is finished, performs a different operation.

When the post process is not to be performed, for example, the first paper ejection tray 16 slides and moves to the position indicated by the dotted line shown in FIG. 3 and can load the sheets of paper P ejected from the standby tray 10 in good consistency. When the post process is not to be performed, the sheets of paper P distributed by the gate 70 via the entrance rollers 22 and conveyed to the paper feed rollers 24 via the paper path ceiling 36 are fed to the standby tray 10 by the paper feed rollers 24. Then, the sheets of paper P are dropped onto the standby tray 10, are conveyed by the standby tray roller 28 rotating in the direction of the arrow f, and are ejected to the first paper ejection tray 16.

In this way, on the first paper ejection tray 16, sheets of paper are sequentially loaded. At this time, the first paper ejection tray 16 is inclined so that the front end side of the sheet of paper is positioned higher than the rear end side thereof. Therefore, the preceding sheet of paper P loaded on the first paper ejection tray 16 is not pressed out by making contact with the front end of the succeeding sheet of paper P. Namely, the ejected sheet of paper P is sequentially loaded on the first paper ejection tray 16 unless the order is disturbed. Further, even if the preceding sheet of paper P is pressed by the succeeding sheet of paper P and is slightly displaced, since the tilt angle is formed, the sheet of paper P drops by its own weight and is loaded on the first paper ejection tray 16 with the rear end matched, and the ejection process of the sheet of paper is completed.

Next, when only the Z-folding process which is the first post process is to be performed and the stapling process is not to be performed, the sheets of paper P distributed by the gate 70 via the entrance rollers 22 and conveyed to the first pair of feed rollers via the folding path 71 are folded by the Z-folding mechanism 68 in a Z shape and are ejected to the first paper ejection tray 16 from the second pair of feed rollers 73.

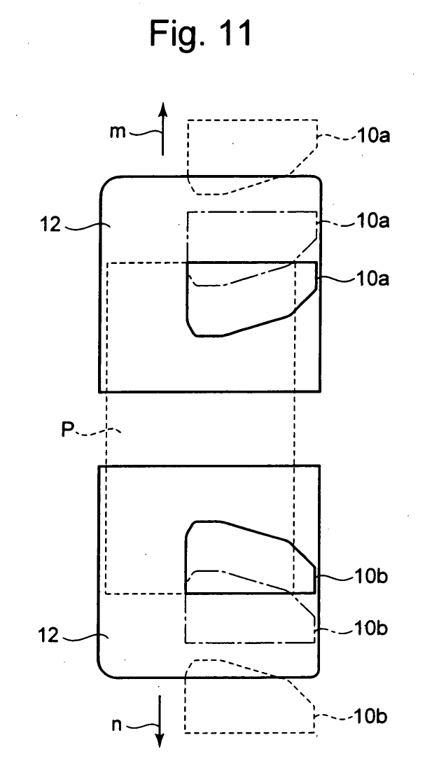

Next, a case that sheets of paper folded in a Z shape, sheets of paper not folded in a Z shape, or sheets of paper composed of both sheets mixed are to be subject to the stapling process and there are no preceding sheets of paper in execution of the stapling process on the processing tray 20 will be described. At this time, the standby tray 10 slides and moves tray members 10a and 10b respectively to the positions indicated by the dotted lines in FIG. 11 in the direction of the arrow m or the direction of the arrow n and opens the dropping and feeding path of the sheets of paper P. Further, horizontal matching plates 47a and 47b, to match horizontally the sheets of paper P dropped from the paper feed rollers 24, are arranged so that the interval between the horizontal matching plates 47a and 47b is made almost equal to the width of the sheets of paper P. By doing this, the sheets of paper P folded in a Z shape and guided by the drop guide 74 from the second pair of feed rollers 73 and the sheets of paper P fed by the paper feed rollers 24 are dropped and fed directly onto the processing tray 12 unless the conveying is disturbed by the standby tray 10.

At the time of dropping and feeding, the upper vertical matching roller 38a is shifted upward and the receiving portion 44a of the paddle 44 receives the rear end of the sheet of paper P. Both sides of the sheet of paper P drop in contact with the horizontal matching plates 47a and 47b and are matched in the horizontal direction. Then, the paddle 44 rotates in the direction of an arrow o, drops the rear end of the sheet of paper P from the receiving portion 44a, and beats down it onto the processing tray 12 by the beating portion 44b. Furthermore, the paddle 44 feeds the sheet of paper P in the direction of an arrow q by the feeding portion 44c, and the rear end of the sheet of paper P makes contact with the stopper 45, and the vertical matching of the sheet of paper P is completed.

When matching the sheet of paper P fed by the processing tray 12 on the basis of the stopper 45 like this, the rear end side 50c of the sheet of paper P on the conveyor belt 50 is lower than the support face of the sheet of paper P on the processing tray 12. Therefore, the contact friction of the rear end of the lowest sheet of paper P with the conveyor belt is small, and the consistency of the sheets of paper P is not disturbed, and the sheet of paper P is matched surely. Further, the vertical matching of the sheet of paper P on the processing tray 12 may be executed by, instead of the paddle 44, the upper vertical matching roller 38a by moving up and down each time.

In this way, the sheets of paper P which an image is formed on and are folded in a Z shape and/or the sheets of paper P fed by the paper feed rollers 24 are loaded directly on the processing tray 12 from the paper feed rollers 24 or the second pair of feed rollers 73 while sequentially matching them in the horizontal direction and vertically direction. When the sheets of paper P reach a predetermined number, the stapler 14 staples the sheets of paper P on the processing tray 12 at a desired position and bundles them to form a sheet bundle T. Hereafter, the upper vertical matching roller 38a is moved down onto the sheet bundle and the sheet bundle T is held between the upper vertical matching roller 38a rotating in the direction of the arrow r and the lower vertical matching roller 38b rotating in the direction of the arrow s and is conveyed toward the first paper ejection tray 16. When the rear end of the sheet bundle T passes the upper and lower vertical matching rollers 38a and 38b, it is hooked by the feed pawl 50a of the conveyor belt 50 rotating in the direction of the arrow t and is fed onto the first paper ejection tray 16.

At this time, the first paper ejection tray 16 slides and moves from the position indicated by the dashed line in FIG. 3 to the position indicated by the solid line. Further, the first paper ejection tray 16 is arranged slantwise and the front end of the sheet of paper is positioned higher than the rear end thereof, so that the preceding sheet of paper P fed onto the first paper ejection tray 16 is not pressed out by making contact with the front end of the succeeding sheet bundle T. Further, even if the preceding sheet bundle T is slightly displaced by the succeeding sheet of paper P, since the tilt angle is formed, the sheet bundle T drops by its own weight and is loaded on the first paper ejection tray 16 with the rear end matched, and the stapling process of the sheets of paper P is completed. The sheet bundle T formed in this way is composed of sheets of paper folded in a Z shape, sheets of paper not folded in a Z shape, or both sheets of paper mixed.

Next, a case that sheets of paper folded in a Z shape, sheets of paper not folded in a Z shape, or both sheets of paper mixed are to be stapled and preceding sheets of paper P in execution of the stapling process remain on the processing tray 12 will be described. At this time, in the standby tray 10, the tray members 10a and 10b slide and move from the positions indicated by the dotted lines in FIG. 11 respectively in the opposite direction of the direction of the arrow m or in the opposite direction of the direction of the arrow n, and are at the positions indicated by the solid lines shown in FIG. 11. By doing this, the tray members 10a and 10b can support the sheets of paper P folded in a Z shape and guided by the drop guide 74 from the second pair of feed rollers 73 and the sheets of paper P fed by the paper feed rollers 24. Further, the standby tray roller 28 is shifted above the standby tray 10 not to disturb the sheets of paper P. The sheets of paper P ejected from the image forming apparatus 5 and folded in a Z shape and/or the sheets of paper P fed by the paper feed rollers 24 are loaded once on the standby tray 10 to wait for the processing tray 12 to be free.

The sheets of paper P loaded on the standby tray 10 are moved down onto the standby tray 10, are sent toward the standby stoppers 10c and 10d by the standby tray roller 28 rotating in the opposite direction of the direction of the arrow f, and are vertically matched with the rear end of the sheets of paper P in contact with the standby stoppers 10c and 10d. Furthermore, the first paper ejection tray 16 is arranged slantwise so that the front end of the sheets of paper is positioned higher than the rear end thereof, thus the sheets of paper P are vertically matched by the own weight with the rear end thereof in contact with the standby stoppers 10c and 10d.

Further, the standby tray 10 is arranged slantwise, so that for example, even if the sheet of paper P is fed from the paper feed rollers 24 in a state that it is curled convexly and is fed to the standby tray 10, the preceding sheet of paper P loaded on the standby tray 10 is not pressed out by making contact with the front end of the succeeding sheet of paper P. Namely, the fed sheet of paper P is sequentially loaded on the standby tray 10 unless the order is disturbed. Further, even if the preceding sheet of paper P is pressed by the succeeding sheet of paper P and is slightly displaced, since the tilt angle is formed, the sheet of paper P drops by its own weight down to the position where the rear end thereof makes contact with the standby stoppers 10c and 10d and is loaded on the standby tray 10 with the rear end matched.

During this period, when the preceding sheet of paper P on the processing tray 12 is ejected on the side of the paper ejection tray 16 and the processing tray 12 becomes free, the standby tray 10 slides and moves the tray members 10a and 10b respectively up to the positions indicated by the dotted lines in FIG. 11 in the directions of the arrows m and n from the positions indicated by the solid lines in FIG. 11 via the positions indicated by the alternate long and short dash line in FIG. 11. By doing this, for example, two sheets of paper P folded in a Z shape standing by on the standby tray 10 and/or the sheets of paper P fed by the paper feed rollers 24, when the tray members 10a and 10b reach the positions indicated by the alternate long and short dash line in FIG. 11, are dropped and fed onto the processing tray 12 from between the tray members 10a and 10b. At this time, the horizontal matching plates 47a and 47b are arranged so as to make the interval between them almost equal to the width of the sheets of paper P. Therefore, the sheets of paper P dropped from the standby tray 10 are controlled on both sides by the horizontal matching plates 47a and 47b and are matched horizontally.

The lower side sheet of paper P of the two sheets of paper P dropped onto the processing tray 12 is sent in the direction of the arrow q by the lower vertical matching roller 38b rotating in the opposite direction of the direction of the arrow s, and the rear end of the sheet of paper P makes contact with the stopper 45, and the vertical matching of the sheet of paper P is completed. The upper side sheet of paper P of the two sheets of paper P dropped onto the processing tray 12 is sent in the direction of the arrow q by the upper vertical matching roller 38a rotating in the opposite direction of the direction of the arrow r. By doing this, the rear end of the sheet of paper P makes contact with the stopper 45 and the vertical matching of the sheet of paper P is completed. Thereafter, the upper vertical matching roller 38a is shifted upward. When matching the sheet of paper P fed by the processing tray 12 on the basis of the stopper 45 like this, the rear end side 50c of the sheet of paper P on the conveyor belt 50 is lower than the support face of the sheet of paper P on the processing tray 12. Therefore, the contact friction of the rear end of the lowest sheet of paper P with the conveyor belt is small, and the consistency of the sheets of paper P is not disturbed, and the sheet of paper P is matched surely.

The sheets of paper P which an image is formed on and are folded in a Z shape by the image forming apparatus 5 and/or the third and subsequent sheets of paper P fed by the paper feed rollers 24 are directly dropped and fed onto the processing tray 12 from between the tray members 10a and 10b without standing by on the standby tray 10. Hereafter, the third and subsequent sheets of paper P are sequentially matched on the sheets of paper P loaded earlier on the processing tray 12 by the paddle 44.

When the sheets of paper P loaded on the processing tray 12 reach a predetermined number, the sheets are stapled by the stapler 14 to form a sheet bundle T. Hereafter, the sheet bundle T is conveyed toward the first paper ejection tray 16 by the upper and lower vertical matching rollers 38a and 38b. Furthermore, the sheet bundle T passing through the upper and lower vertical matching rollers 38a and 38b, after the rear end thereof is hooked by the feed pawl 50a of the conveyor belt 50, is conveyed onto the first paper ejection tray 16. The sheet bundle T completed in the stapling process and conveyed onto the paper feed tray 16 in this way is composed of sheets of paper folded in a Z shape, sheets of paper not folded in a Z shape, or both sheets of paper mixed.

According to this embodiment, when the stapling process is to be performed after image forming and the preceding stapling process is not finished on the processing tray 12, the standby tray 10 is installed above the processing tray 12 and waits for the succeeding sheets of paper P. And, waiting for the processing tray 12 to become free, the sheets of paper P standing by on the standby tray 10 are dropped and fed and then are moved to the processing tray 16. Therefore, the practical conveying path from the standby tray 10 in the sheet post-process apparatus 7 to the processing tray 12 can be shortened and the sheet post-process apparatus can be miniaturized.

Further, the Z-folding mechanism 68 is arranged above the standby tray 10 and drops and feeds the sheets of paper P folded in a Z shape onto the standby tray 10 or the processing tray 12, so that even when the Z-folding process is to be performed, the sheet post-process system can be miniaturized. Furthermore, the sheets of paper P folded in a Z shape can be mixed with the sheets of paper P directly fed to the paper feed rollers 24 from the image forming apparatus 5 by the standby tray 10 or the processing tray 12 and can be stapled, so that a hyperfunctioned sheet post-process system, though it is compact, capable of performing various post processes can be realized.

Further, the present invention is not limited to the aforementioned embodiment and can be variously modified within the scope of the present invention. For example, the method for dropping and feeding sheets from the standby tray onto the processing tray is not limited and the standby tray rotates and moves instead of sliding and moving, thus sheets of paper on the standby tray may be dropped and fed onto the processing tray. Further, the first and second processing apparatuses are not limited, and the first processing mechanism, if it is a post process to be performed for sheets, may be a doubling apparatus, and the second processing mechanism may be a hole puncher. Furthermore, in addition to the first and second processing apparatuses, a third processing mechanism for dropping different sheets as a partition onto the standby tray or processing tray is installed above the standby tray and for example, between sheets of paper to be stapled, different sheets may be inserted as a partition.

As described in detail above, according to the present invention, the standby tray for making sheets stand by is installed above the processing tray for performing the post process and the sheets standing by on the standby tray are dropped and fed onto the processing tray. Therefore, in the apparatus, the distances occupied by the standby tray and processing tray can be overlapped, and the practical conveying path from the paper ejection section of the image forming apparatus body to the processing mechanism for performing the post process can be shortened, and the sheet post-process apparatus can be miniaturized.

What is claimed is:

1. A sheet post-process system, comprising:
a first processing mechanism configured to perform a first post process for sheets;
a standby tray arranged under the first processing mechanism configured to catch the sheets dropped from the first processing mechanism, and load other sheets which are provided after the sheets;
a processing tray arranged under the standby tray configured to load the sheets dropped from the standby tray and the sheets which are provided after the sheets or the first processing mechanism not via the standby tray; and
a second processing mechanism configured to perform a second post process for the sheets loaded on the processing tray before the standby tray drops the other sheets onto the processing tray.

2. The sheet post-process system according to claim 1, further comprising a paper ejection tray loading the sheets at least after ending the second post process.

3. The sheet post-process system according to claim 1, wherein the first processing mechanism is a Z-folding mechanism.

4. The sheet post-process system according to claim 1, wherein the second processing mechanism is a stapler for bundling the sheets loaded on the processing tray.

5. The sheet post-process system according to claim 1, wherein the standby tray is composed of at least a pair of tray members for respectively supporting both sides of the sheets and slides and moves the tray members to drop and feed the sheets onto the processing tray.

6. The sheet post-process system according to claim 2, wherein the paper ejection tray can load the sheets ejected from the standby tray not via the processing tray.

7. The sheet post-process system according to claim 1, further comprising a gate configured to branch the sheets to either of the first processing mechanism and to the standby tray.

8. The sheet post-process system according to claim 5, further comprising a gate configured to branch the sheets to either of the first processing mechanism and to the standby tray, wherein the standby tray is moved to a position which does not disturb a dropping of the sheets not to be performed the first post process during the gate branches the sheets to the standby tray and the standby tray drops the sheets onto the processing tray.

9. The sheet post-process system according to claim 1, further comprising a pair of vertical matching rollers which aligns the sheets held on the processing tray.

10. A sheet post-processing method, comprising:
performing a first post process for sheets by a first processing mechanism;
catching the sheets dropped from the first processing mechanism, and loading other sheets which are provided after the sheets on a standby tray;
loading the sheets dropped from the standby tray and the sheets which are provided after the sheets or the first processing mechanism not via the standby tray on a processing tray; and
performing a second post process for the sheets loaded on the processing tray, before the standby tray drops the other sheets onto the processing tray.

11. The sheet post-processing method according to claim 10, further comprising loading the sheets at least after ending the second post process and ejected from the processing tray on a paper ejection tray.

12. The sheet post-processing method according to claim 10, wherein the first processing mechanism is a Z-folding mechanism.

13. The sheet post-processing method according to claim 10, wherein the second processing mechanism is a stapler for bundling the sheets loaded on the processing tray.

14. The sheet post-processing method according to claim 10, wherein the standby tray is composed of at least a pair of tray members for respectively supporting both sides of the sheets and slides and moves the tray members to drop and feed the sheets onto the processing tray.

15. The sheet post-processing method according to claim 11, wherein the paper ejection tray can load the sheets ejected from the standby tray not via the processing tray.

16. The sheet post-processing method according to claim 10, further comprising making branch the sheets to either of the first processing mechanism and to the standby tray.

17. The sheet post-processing method according to claim 14, further comprising branching the sheets to either of the first processing mechanism and to the standby tray, wherein the standby tray is moved to a position which does not disturb a dropping of the sheets not to be performed the first post process during the gate branches the sheets to the standby tray and the standby tray drops the sheets onto the processing tray.

18. The sheet post-processing method according to claim 10, further comprising loading the plurality of sheets after performing a second post process by a pair of vertical matching rollers.
